(19) United States
(12) Patent Application Publication
(10) Pub. No.: US 2006/0263759 A1
(43) Pub. Date: Nov. 23, 2006

(54) Dried blood plasma product

(76) Inventors: Odilio Alves-Filho, Trondheim (NO); Ola Bergslien, Trondheim (NO); Peter Vjork, Trondheim (NO); Tryve Magne Eikevik, Trondheim (NO); Ingvald Strommen, Trondheim (NO)

Correspondence Address: SUGHRUE MION, PLLC, 2100 PENNSYLVANIA AVENUE, N.W., SUITE 800, WASHINGTON, DC, 20037, US

(21) Appl. No.: 10/548,294

(22) PCT Filed: Mar. 8, 2004
(86) PCT No.: PCT/GB04/00968

§ 371 Date: Jul. 13, 2006

(30) Foreign Application Priority Data
Mar. 6, 2003 (GB) 0305133.1

(51) Int. Cl. A01N 1/02

(52) U.S. Cl. 435/2

(57) ABSTRACT

The present invention provides a fluidized bed dried blood plasma.

The present invention relates to reconstitutable dried blood plasma, processes for its preparation and reconstitution, and its medical and non-medical (e.g. research) uses.

Plasma is the electrically neutral, aqueous solution of electrolytes, proteins and small organic molecules which comprises 60% of the volume of whole blood. It contains among other things coagulation factors, immunoglobulins, complement proteins and transport proteins.

Plasma has a variety of important uses, for example: treatment of patients with burns, shock and coagulation disorders whether it is primary disease or post traumatic (accidental or surgical). It is also used in the treatment of several immune disorders.

Fresh frozen plasma is a source of all coagulation proteins and other plasma proteins and thus is used after severe loss of blood, during major surgery or when depletion of plasma protein has taken place and to reverse anticoagulant treatment. It can also be used to replace coagulation factors after massive blood transfusions or in situations where coagulation factors are not being sufficiently produced.

Plasma is also processed to provide plasma components such as albumin which is mainly used to treat shock or burn victims. It is also of interest in cases of organ preservation as transplantation activity increases. Other plasma components include Factor VIII for the treatment of bleeding disorders.

Processed plasma is also essential for cases where specific antibodies are extracted for application in clinical medicine where the aim is to raise the level of a specific antibody for a limited period of time. The antibodies in question could be antibodies related to diseases like tetanus, hepatitis, varicella, chickenpox and rabies as well as anti-D which is used for Rh negative pregnant women carrying Rh positive babies.

Hospitals carry stocks of fresh frozen plasma for use for example during surgical procedures.

Health authorities and hospitals thus generally rely on a continuous collection, separation and storage of blood to meet their normal needs, and in order to maintain supplies at maximum levels, patients demanding blood products are routinely supplied with the oldest supplies still within their permitted storage times, i.e. supplies in sub-optimal condition. Where supplies are insufficient to meet demand, e.g. in the case of an event with many casualties or where an individual with a rare blood group is in need of large quantities of a compatible blood product, fresh supplies need to be transported from remote locations, thereby risking patients' lives if opportunities for supply and transport are restricted.

As a result, in the case of a major accident or of an event with large numbers of casualties, hospitals and health authorities risk having an inadequate supply of blood products available for transfusions. In such circumstances, the hospitals and health authorities cannot rely upon being able to recruit donors and to collect sufficient blood within the necessary time—not least because the donors' blood must be checked for any disease (e.g. HIV infection) before it is used.

There is thus a need for such blood products which can be stored for periods longer than is currently possible and yet can be rapidly reconstituted for transfusion into a patient when the need arises, e.g. when supplies of blood products of the correct type are exhausted. Moreover there is an additional demand for blood products that are a safer and more reliable alternative to the materials currently available for transfusions. Furthermore, the logistics for blood products both in remote regions and large urban centres are complicated by the bulk of the current products and their refrigeration requirements.

A particularly desirable such product is reconstitutable dried plasma. Coagulation factor concentrates are available as high purity freeze-dried powders and vacuum freeze-dried plasma is known but has the disadvantage of a relatively long drying time and thus high costs.

We have now surprisingly found that it is possible to produce dried plasma, to store it under ambient conditions or relatively mild refrigeration, and to reconstitute the products to produce a transfusion fluid even after storage periods significantly in excess of the maximum storage period for equivalent refrigerated blood products. The drying time is also significantly reduced by using a fluidized bed dryer.

Thus viewed from one aspect the invention provides a fluidized bed dried blood plasma. The drying of this product is typically carried out at low to medium temperatures.

The dried product, on rehydration with distilled water to an osmolality within the range normal for the relevant species' blood and at a temperature within 1° C. of the normal daytime body temperature of the relevant species, is a suitable alternative to fresh or fresh frozen plasma, and the retention of the efficacy of proteins and other relevant substances is surprisingly better than is the case with vacuum freeze-dried plasma. In relation to relevant blood substances such as albumin, antibodies (e.g. antibody to varicella-zoster virus and other IgG) and factor VIII, the content maintained in the product of the invention is at least as good as or better than that produced by conventional techniques. In particular, contents of IgG, albumin and antibody to varicella zoster virus are superior in the product of the invention when compared to products produced by conventional techniques, such as vacuum freeze drying.

Viewed from a further aspect the invention provides a process for the preparation of a fluidized bed dried blood plasma, said process comprising:

obtaining a plasma sample from a mammalian subject;

freezing said sample;

granulating the frozen sample;

sieving the granulated frozen sample to remove particles <400 μm; preferably <800 μm

drying the sieved frozen sample in a fluidized bed dryer at a temperature between −5° C. and −20° C.;

and optionally further drying said sieved sample in a fluidized bed drier at a temperature of −5° C. to 45° C., preferably 0° C. to 30° C., especially 10° C. to 25° C.

Viewed from a further aspect the invention provides a dried, reconstitutable biological product comprising fluidized bed dried blood plasma.

Prior to freezing, the plasma can undergo antiviral chemical treatment, dialysis and/or removal of antibodies.

The product of the invention can be stored at 4° C. and reconstituted with distilled water. Prior to reconstitution, the sample may be irradiated. The reconstituted product may be filtered if necessary and optionally frozen for further storage.

The initial drying of the particulate is effected at a temperature in the range −5 to −20° C., especially −6 to −15° C., particularly −8 to −12° C., e.g. about −10° C. In order to accelerate the drying procedure a subsequent higher temperature drying step may be used, e.g. at 10 to 25° C. as mentioned above. A further drying phase at up to +45° C., more preferably up to +20° C. may be undertaken. The duration of the drying process will depend upon the temperatures used but will preferably not exceed 10 hours. A drying period of up to 8 hours is preferred.

Drying is preferably effected so as to achieve a total moisture content in the dried product of 1 to 20% wt, more preferably 2 to 17% wt, especially 5 to 12% wt, more especially 7 to 10% wt.

In the drying procedure, conventional drying media (e.g. air, nitrogen, etc.) may be used; however it is preferred to use nitrogen, reduced oxygen content air, or noble gases.

The gas pressure in the drying procedure is preferably within 10% of ambient air pressure.

In place of the conventional fluidized bed driers, where gas is used to fluidize the particle bed, in the process of the invention one may instead use a drier in which the bed is fluidized mechanically, e.g. by counter-rotating parallel arms carrying screws or paddles. Such mechanically fluidized beds have been used for example in the polymer industry for impregnation of metallocene catalysts into particulate carriers (see for example patent applications from Borealis). If mechanical fluidization is used, the gas pressure in the drier is preferably sub-ambient.

If desired, to increase protein viability in the dried product, a water-soluble protective polymer such as a polyether (eg a polyalkyleneoxide such as PEG) or a polysaccharide or a sugar (such as trehalose) or a “neutral” polypeptide (such as polyglycine) may be added to the plasma before drying is effected. Quantities of, for example, 1% wt or more may be used in this regard.

The particles that result from the granulation step in the process of the invention are preferably in solid or gel form, particularly solid form. The particle size (i.e. mode particle diameter) is preferably in the range 0.05 to 5 mm, more preferably 0.4 to 3.4 mm, more especially 0.5 to 3 mm. Accordingly, if desired the particles may be graded (e.g. sieved) before use to select particles of the desired size. Substantial uniformity of particle size results in substantially uniform drying of the particles.

As a prior step to the required steps of the process of the invention, a blood sample may be treated to produce the plasma by cell removal. This may be done by any suitable cell removal procedure, e.g. filtration. However centrifugation is preferably used. Centrifugation is conventionally used following blood donation to produce blood cell concentrates and cell-free plasma which are separated before being stored. The cell removal step may involve several cycles of centrifugation, separation, dilution, centrifugation, etc.

Following cell removal, the plasma may be stored under refrigeration (e.g. 1 to 4° C.), typically for up to 35 days before further processing. However the plasma is preferably further processed with minimal delay, preferably no more than 7 days, more preferably no more than 24 hours.

While the invention is applicable to blood from all animals having a vascular system, it is especially applicable to mammalian blood, and in particular human blood.

In the sample collection stage, blood is preferably collected from healthy donors, e.g. using international recommendations from the relevant health authorities or, in Norway, from the Norwegian Health Ministry.

Blood collection is described for example in Chapter 11 of Basic and Applied Concepts of Immunohematology by Blaney et al, Mosby, 2000.

The sample is then subjected to cell removal, e.g. using a conventional centrifuge. The resulting plasma may then be processed further immediately or stored under refrigeration (e.g. 1 to 4° C.), typically for up to five weeks before further processing.

The dried particulate plasma is conveniently packaged into containers which are then sealed. Preferably the gas in the sealed containers is oxygen-free, e.g. nitrogen or helium. The sealed containers may be stored at ambient temperature but desirably are stored frozen or under refrigeration or freezing, e.g. −20 to +10° C., preferably −10 to +4° C.

The dried plasma product may be reconstituted by mixing with a sterile aqueous solution, preferably one which, in combination with the dried product, will yield a solution which is within 10% of being isoosmolar with normal fresh plasma.

Thus viewed from a further aspect the invention provides a method of production of a transfusion liquid, said method comprising dispersing a dried particulate plasma according to the invention in a physiologically tolerable sterile aqueous solution.

In order to simplify the reconstitution process and make it suitable for automation, a method involving the use of constant dosage pipettes has been developed. The powder product is weighed out so that a fixed amount of liquid is required to provide a solution that has the same initial moisture content as fresh plasma. This provides a further aspect of the invention.

Viewed from a further aspect the invention provides a kit comprising a first container containing a dried particulate plasma according to the invention, and a second container containing a sterile physiologically tolerable aqueous reconstitution solution.

Where it is desired that the transfusion liquid contain more than one type of blood component, e.g. erythrocytes, platelets, and plasma proteins, it is possible to use a combination of separately produced dried blood products, e.g one containing erythrocytes and a second according to the invention. The combination may be brought together before or after reconstitution.

The invention will now be described further with reference to the following non-limiting Examples.

### EXAMPLE 1

Preparation of Fluidized Bed Dried Plasma

Fresh frozen plasma (200 ml OCTAPLAS from Octapharma AG) was freeze-granulated into 3 mm spheres at −20° C. and sieved to remove particles <800 μm. The resulting particulate was then dried in a fluidized bed dryer at the temperatures shown in Table 1. Samples 2, 5 and 6 underwent a second drying stage at +20° C. The dried yellow/white powder samples were then vacuum packed.

TABLE 1

| | | | | | Average |
|---|---|---|---|---|---|
| | | Drying | Initial | Final | final |
| | Blood | temperature | moisture | moisture | Density |
| Sample | type | (° C.) | level(%) | level(%) | (gl⁻¹) |
| 1 | A | −5 | 92.0 | 7.8 | 186 |
| 2 | AB | −10/+20 | 91.68 | 13.97 | 233 |
| 3 | AB | −10 | 92.0 | 9.8 | 218 |
| 4 | AB | −15 | 92.0 | 12.02 | 182 |
| 5 | AB | −15/+20 | 92.15 | 8.0 | 180 |
| 6 | AB | −5/+20 | 92.0 | 8.11 | 184 |

### EXAMPLE 2

Reconstitution of Dried Product

Samples of dried plasma product produced as described in Example 1 were rehydrated with distilled water to 200 ml after 6 months' storage at +4° C. The powder dissolved very well. The resulting liquid was yellow and plasma-like.

The reconstituted samples 1, 2, 3, 5 and 6 were analysed for activated partial thromboplastin time (APTT), IgG and albumin. The results are shown in Table 2 below.

TABLE 2

| Sample | APTT(s) | IgG (gl⁻¹) | Albumin (gl⁻¹) |
|---|---|---|---|
| 1 | >150 | 2.91 | 0.65 |
| 2 | >150 | 13.8 | 2.94 |
| 3 | 115 | 19.5 | 4.25 |
| 5 | >150 | 8.28 | 1.79 |
| 6 | 117 | 17.0 | 3.75 |

### EXAMPLE 3

Preparation of Fluidized-Bed Dried Plasma

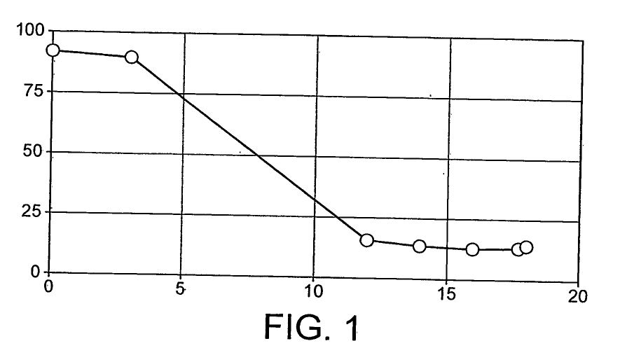

8 litres of fresh-frozen and virus inactivated plasma was obtained from the blood bank of the Sain Olavs Hospital in Trondheim, Norway. The plasma was contained in 200 ml bags, all bags were type A plasma and taken from pooled batches. Prior to preparation and drying the bags were kept at −45° C. A low-medium temperature fluidized bed dryer was used to process the batches, which were labelled FBD1, FBD2, FBD3, FBD4, FBD5 and FBD6. The samples were dried at a single low temperature mode of −15° C., −10° C. and −5° C. or at a low-medium temperature which included a combination of −15° C. with +20° C., −10° C. with +20° C. and −5° C. with +20° C. After being warmed from −45° C. to −10° C., all batches were granulated and sieved to obtain particles between 3.4 mm and 400 μm. These granulated batches were stored at −25° C. until dried. A typical drying curve is presented in FIG. 1 which shows moisture content versus time for low temperature fluidized-bed drying at −10° C. The vertical axis shows moisture content in percent by wet basis (% wb) while the horizontal axis shows time during drying with an air inlet temperature of 10° C. in hours.

### EXAMPLE 4

Method for Powder Reconstitution

After adding distilled water, all powder samples prepared as in Example 3 reconstituted quickly in a time range of 1 to 2 minutes. A method was developed to provide a standard reconstitution procedure and easier handling by operators of the measuring devices. The operator or assistant had only to add a constant volume of distilled water to the powder samples prior to insertion into the measuring chamber. Considering the final moisture of the powders, each sample mass was calculated and weighted in a way that the fixed amount of distilled water was added as to obtain a solution that had the same initial moisture content as the fresh-frozen or the plasma references. The procedure is summarised as follows:
Weigh the powder in test tube that fits the chamber of the measuring devices (for example: 0.088 to 0.101 grams per tube)
Add 1 or 2 ml of distilled water using constant dosing pipette
Shake the tube for uniform mixing
Fit tube into the measuring machine and get data.

### EXAMPLE 5

Analysis and Results

Tha samples obtained from Examples 3 and 4 were analysed for albumin, immunoglobulin IgG and the antibody to varicella-zoster/IgG at Saint Olavs Hospital in Trondheim and factor VIII at the Riks hospital in Oslo. An immunoassay was used to detect and to quantify the antibody to varicella-zoster/IgG. The results are shown in Tables 3 to 6.

TABLE 3
Albumin Analysis (g/l) Normal values for adults
of 14-50 years = 40 to 50 g/l

| | | | | | Mean |
|---|---|---|---|---|---|
| | | Test number | | | |
| | | 11 | 12 | 13 | |
| FBD1 | −15° C. | 36 | 34 | 34 | 34.67 |
| | | Test number | | | |
| | | 21 | 22 | 23 | |
| FBD2 | −10° C. | 37 | 39 | 37 | 37.67 |
| | | Test number | | | |
| | | 31 | 32 | 33 | |
| FBD3 | −5° C. | 34 | 35 | 35 | 34.67 |
| | | Test number | | | |
| | | 41 | 42 | 43 | |
| FBD4 | −15/+20° C. | 37 | 38 | 37 | 37.33 |
| | | Test number | | | |
| | | 51 | 52 | 53 | |
| FBD5 | −10/+20° C. | 36 | 35 | 35 | 35.33 |
| | | Test number | | | |
| | | 61 | 62 | 63 | |
| FBD6 | −5/+20° C. | 36 | 33 | 34 | 34.33 |
| | | Test number | | | |
| | | 201A | 202A | 203A | |
| Ref T-F | | 37 | 35 | 36 | 36.00 |
| | | Test number | | | |
| | | 201B | 202B | 203B | |
| Ref T-F | | 37 | 37 | 37 | 37.00 |
| | | Test number | | | |
| | | 204A | 205A | 206A | |
| Ref T-F | | 37 | 34 | 35 | 35.33 |
| | | Test number | | | |
| | | 204B | 205B | 206B | |
| Ref T-F | | 35 | 35 | 37 | 35.67 |
| | | Test number | | | |
| | | 301A | 302A | 303A | |
| Ref Gran | | 35 | 35 | 35 | 35.00 |
| | | Test number | | | |
| | | 301B | 302B | 303B | |
| Ref Gran | | 34 | 34 | 35 | 34.33 |

TABLE 4
Immunoglobulin-IgG Analysis (g/l) Normal
values for men = 6.1 to 14.9

| | | | | | Average |
|---|---|---|---|---|---|
| | | Test number | | | |
| | | 11 | 12 | 13 | |
| FBD1 | −15° C. | 7.4 | 7.7 | 7.6 | 7.57 |
| | | Test number | | | |
| | | 21 | 22 | 23 | |
| FBD2 | −10° C. . | 8.1 | 8.0 | 7.9 | 8.00 |
| | | Test number | | | |
| | | 31 | 32 | 33 | |
| FBD3 | −5° C. | 6.9 | 7.3 | 7.2 | 7.13 |
| | | Test number | | | |
| | | 41 | 42 | 43 | |
| FBD4 | −15/+20° C. | 8.0 | 7.9 | 7.7 | 7.87 |
| | | Test number | | | |
| | | 51 | 52 | 53 | |
| FBD5 | −10/+20° C. | 7.6 | 7.6 | 7.5 | 7.57 |
| | | Test number | | | |
| | | 61 | 62 | 63 | |
| FBD6 | −5/+20° C. | 7.5 | 7.0 | 7.1 | 7.20 |
| | | Test number | | | |
| | | 201A | 202A | 203A | |
| Ref T-F | | 7.2 | 7.3 | 7.3 | 7.27 |
| | | Test number | | | |
| | | 201B | 202B | 203B | |
| Ref T-F | | 7.2 | 7.4 | 7.2 | 7.27 |
| | | Test number | | | |
| | | 204A | 205A | 206A | |
| Ref T-F | | 7.5 | 7.4 | 7.5 | 7.47 |
| | | Test number | | | |
| | | 204B | 205B | 206B | |
| Ref T-F | | 7.4 | 7.7 | 7.4 | 7.50 |
| | | Test number | | | |
| | | 301A | 302A | 303A | |
| Ref Gran | | 7.2 | 7.0 | 6.9 | 7.03 |
| | | Test number | | | |
| | | 301B | 302B | 303B | |
| Ref Gran | | 7.3 | 7.1 | 7.3 | 7.23 |

TABLE 5
Antibody to Varicella-Zoster Virus/IgG Analysis Optical density readings
- value of greater than 0.1 indicates presence of antibodies.

| | | | | | Average |
|---|---|---|---|---|---|
| | | Test number | | | |
| | | 11 | 12 | 13 | |
| FBD1 | −15° C. | 1.384 | 1.356 | 1.384 | 1.375 |
| | | Test number | | | |
| | | 21 | 22 | 23 | |
| FBD2 | −10° C. | 1.336 | 1.182 | 1.137 | 1.218 |
| | | Test number | | | |
| | | 31 | 32 | 33 | |
| FBD3 | −5° C. | 1.450 | 1.383 | 1.413 | 1.415 |
| | | Test number | | | |
| | | 41 | 42 | 43 | |
| FBD4 | −15/+20° C. | 1.277 | 1.448 | 1.145 | 1.290 |
| | | Test number | | | |
| | | 51 | 52 | 53 | |
| FBD5 | −10/+20° C. | 1.265 | 1.271 | 1.271 | 1.269 |
| | | Test number | | | |
| | | 61 | 62 | 63 | |
| FBD6 | −5/+20° C. | 1.218 | 1.435 | 1.253 | 1.302 |
| | | Test number | | | |
| | | 201A | 202A | 203A | |
| Ref T-F | | 1.167 | 1.996 | 2.044 | 1.736 |
| | | Test number | | | |
| | | 201B | 202B | 203B | |
| Ref T-F | | 1.184 | 1.355 | 1.413 | 1.317 |
| | | Test number | | | |
| | | 301A | 302A | 303A | |
| Ref Gran | | 1.485 | 1.096 | 1.098 | 1.226 |
| | | Test number | | | |
| | | 301B | 302B | 303B | |
| Ref Gran | | 1.220 | 1.172 | 1.167 | 1.186 |

TABLE 6
Factor VIII Analysis (%)

| | | | | | Average |
|---|---|---|---|---|---|
| | | Test number | | | |
| | | 11 | 12 | 13 | |
| FBD1 | −15° C. | 57 | 68 | 55 | 60.00 |
| | | Test number | | | |
| | | 21 | 22 | 23 | |
| FBD2 | −10° C. | 41 | 36 | 35 | 37.33 |
| | | Test number | | | |
| | | 31 | 32 | 33 | |
| FBD3 | −5° C. | 51 | 48 | 58 | 52.33 |
| | | Test number | | | |
| | | 41 | 42 | 43 | |
| FBD4 | −15/+20° C. | 50 | 48 | 40 | 46.00 |
| | | Test number | | | |
| | | 51 | 52 | 53 | |
| FBD5 | −10/+20° C. | 61 | 59 | 59 | 59.67 |
| | | Test number | | | |
| | | 61 | 62 | 63 | |
| FBD6 | −5/+20° C. | 51 | 56 | 53 | 53.33 |
| | | Test number | | | |
| | | 201 | 202 | 203 | |
| Ref T-F | | 58 | 49 | 49 | 52.00 |
| | | Test number | | | |
| | | 301 | 302 | 303 | |
| Ref Gran | | 48 | 52 | 52 | 50.67 |

In tables 3 to 6, “Ref T-F” is the reference taken from plasma that was thawed and frozen (i.e. the type of sample that would be used for vacuum freeze drying) and “Ref Gran” signifies the reference taken from plasma that was granulated while frozen. Neither type of reference sample had been dried.

Variant statistical analysis was carried out on the results shown in tables 3 to 6 for the product of the invention and the Ref T-F samples. These showed that the superior values obtained for the product of the invention were almost certainly due to the process differences in process, rather than random factors (Albumin: significant to 0.14%; IgG: significant to 0.00031%; Antibody to the Varicella-Zoster Virus: significant to 0.019%).

These results show that the product of the invention maintains albumin, IgG and the antibody to the Varicella-Zoster Virus contents that are significantly superior to those found for the Ref T-F samples.

1. A fluidized bed dried blood plasma.

2. A process for the preparation of a fluidized bed dried blood plasma, said process comprising the steps of:
(A) obtaining a plasma sample from a mammalian subject;
(B) freezing said sample;
(C) granulating the resulting frozen sample;
(D) sieving the resulting granulated frozen sample to remove particles <400 μm;
(E) drying the resulting sieved frozen sample in a fluidized bed dryer at a temperature between −5° C. and −20° C.; and
(F) optionally, further drying the resulting sieved sample in a fluidized bed dryer at a temperature of −5° C. to 45° C.

3. The process as claimed in claim 2, wherein said granulated frozen sample is sieved to remove particles <800 μm.

4. The process as claimed in claim 2, wherein said sieved sample is further dried in a fluidized bed dryer at a temperature of −5° C. to 45° C.

5. The process as claimed in claim 2, wherein said sieved sample is further dried in a fluidized bed dryer at a temperature of 0° C. to 30° C.

6. The process as claimed in claim 2, wherein said sieved sample is further dried in a fluidized bed dryer at a temperature of 10° C. to 25° C.

7. The process as claimed in any one of claims 1 to 6, wherein drying is effected to a moisture content of 5 to 12% wt.

8. A method of production of a transfusion liquid, said method comprising dispersing a dried particulate plasma according to claim 1 or produced in any one of claims 2 to 6 in a physiologically tolerable sterile aqueous solution.

9. A kit comprising a first container containing a dried particulate plasma according to claim 1 or produced as claimed in any one of claims 2 to 6, and a second container containing a sterile physiologically tolerable aqueous reconstitution solution.
